(19) United States
(12) Patent Application Publication
(10) Pub. No.: US 2026/0051223 A1
(43) Pub. Date: Feb. 19, 2026

(54) Pre-Truncation of Game Outcomes in a Random Gaming Environment

(71) Applicant: Aristocrat Technologies, Inc., Las Vegas, NV (US)

(72) Inventors: Daniel Marks, Decatur, GA (US); Hua Xu, Marietta, GA (US)

(21) Appl. No.: 19/287,011

(22) Filed: Jul. 31, 2025

Related U.S. Application Data
(60) Provisional application No. 63/683,562, filed on Aug. 15, 2024.

(51) Int. Cl. G07F 17/32

(52) U.S. Cl. CPC G07F 17/3262; G07F 17/3213

(57) ABSTRACT

A technique for pre-truncating potential game outcomes includes simulating a plurality of game outcomes for an electronic game, and determining whether each of the plurality of game outcomes satisfies an inclusion criterion. Game outcomes that fail to satisfy the inclusion criterion are excluded to obtain a subset of the plurality of game outcomes. The technique also includes generating a weighted table comprising the subset of the plurality of game outcomes to satisfy a weighting criterion. The electronic game utilizes the weighted table for selecting one or more of the subset of the plurality of game outcomes during a game session. Game outcomes include wins, nudge-based potential wins, and losses.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Typically, multiple EGMs of different types and/or that implement different games are disposed on a gaming area managed for example by a casino operator, and the casino operator selects the EGMs, the games that are implemented and the locations of the EGMs on the gaming area according to defined criteria.

RTP and randomness of the RNG is typically regulated by different governing bodies or regulators in their respective markets, such as the Atlantic Lottery Corporation in Atlantic Canada or the Nevada Gaming Commission in Las Vegas. For some games, a max win payout may be determined for the game or game outcomes by regulators in their respective markets. In some cases, the max win payout may vary by market, creating a need to configure games to comply with max win requirements.

### SUMMARY

The present embodiments may relate to, inter alia, systems and methods for improving gaming device operation and capability by reducing the complexity in porting a class 3 game to other gaming markets, such as the Atlantic Lottery Corporation (ALC) market that have max win requirements. In one implementation, rather than truncating game outcomes, the game may be configured with a pre-truncation operation that removes winning outcomes that exceed the max win. Additionally, or alternatively, the game may be preconfigured with a predefined number of outcomes, where each of the predefined outcomes is less than or equal to the max win limit. In another embodiment, the pre-truncation technique may be used for markets that have a skill requirement, such as the Georgia COAM (Coin Operated Amusement Machine) market. The pre-truncation operation functions in line with such market-specific constraints by removing potential game outcomes that would result in an immediate win, thereby failing to require a skill element.

In one aspect, a gaming device including a player interface, a display system, a control system comprising one or more processors, and a memory in communication with the control system may be provided. The memory may store computer-readable instructions executable by a processor. The processor may be configured to: i) iterate or simulate a plurality of game outcomes for an electronic game, ii) label a first subset of the plurality of game outcomes determined to indicate a result above a threshold, iii) remove the first subset from the plurality of game outcomes to create a second subset of the plurality of game outcomes, and iv) apply the second subset to a weighted table for use by one or more instances of the electronic game. The gaming device may include additional, less, or alternate functionality, including that discussed elsewhere herein.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts an exemplary process implemented by a computing device for performing a pre-truncation operation to port an electronic game in accordance with an exemplary embodiment of the present disclosure.

FIG. 5 depicts an example set of data structures for potential outcomes, in accordance with one or more embodiments.

FIG. 6 depicts an exemplary process implemented by a computing device for performing a pre-truncation process for a nudge-based game, in accordance with an exemplary embodiment of the present disclosure.

FIG. 7 depicts an example set of data structures for potential outcomes, in accordance with one or more embodiments.

FIG. 8 depicts an example diagram of a nudge-based win, in accordance with one or more embodiments.

FIG. 9 depicts a flowchart of an example process for performing a game instance on an electronic gaming machine using a pre-truncated lookup table.

### DETAILED DESCRIPTION

The disclosure is directed to various embodiments of techniques for improving gaming device operation and capability involves reducing the complexity in porting an electronic game, such as a class 3 game, to other gaming markets, such as the Atlantic Lottery Corporation (ALC) market that have max win requirements. In one implementation, rather than truncating game outcomes during gameplay, the game may be configured with a pre-truncation operation that removes winning outcomes that exceed the max win requirements. Additionally, or alternatively, the game may be preconfigured with a predefined number of outcomes, where each of the predefined outcomes is less than or equal to the max win limit or threshold.

Embodiments described herein are directed to solving a technical problem that arises when a spin outcome must satisfy certain criteria, and the reels from which the spin outcome is determined allow for additional outcomes that do not satisfy the criteria. As an example, an electronic game, such as a class 3 game, can be ported over to gaming markets with max win requirements. Previously, when porting a class 3 game, the game could generate a game outcome for a single spin that exceeds the max win limit. When the game generates such a random game outcome, the game truncates/caps the win amount to the max win limit. For example, for a given spin, the game could generate a game outcome that pays out $5,000 when the max win limit is $1,200. Because of such max win limit, the game would truncate/remove $3,800 from the winnings and present to the player that he or she won $1,200. During the porting process, because such wins are taken away from the player, the RTP designated for a bonus feature would need to be somehow reallocated to other parts the game. Performing such truncation operations make the game porting process less efficient and more complex. Recently, certain jurisdictions no longer allow for games to truncate payout so that the payout falls within the max win limit.

Alternatively, in prior solutions, the game may be configured such that for any game outcome generated that exceeds the max win limit, or in the case of a skill-based requirement the outcome results in an immediate win, the game outcome is discarded and not shown to the player. The game may continue to use a brute force method and continue generating game outcomes until a game outcome satisfies the criteria for a win. In doing so, excess compute resources may be used, and a delay may appear in the game.

The technical solution provided herein involves generating a specialized weighted table for an electronic game based on allowable outcome criteria, which may be specific to a particular machine, property, game, game family, or the like. The process includes pre-processing potential game outcomes before gameplay commences. The potential outcomes are filtered to remove those that fail to satisfy a predefined criteria. The remaining outcomes are used to generate a weighted table by applying weights to the remaining outcomes to satisfy an overall weighting criteria. The weighted table can then be used in the electronic game to select game outcomes.

In some embodiments, the disclosed systems and methods, technically rooted in gaming in technology, uses a pre-truncation operation as games (e.g., class 3 games) are ported over to markets having max win limits. A technical effect of the systems and processes described herein may be achieved by performing at least one of the following steps: (i) in response to a bonus feature being triggered, select, using a weighted table, one of several predefined feature game outcomes, (ii) configure the predefined feature game outcomes to have a varying number of spins so that each spin is configured to generate payouts that are within the max win limits, (iii) base the predefined feature game outcomes on calculated or simulated results (e.g., calculated or simulated results of class 3 games) to ensure variability and/or randomness, and (iv) eliminate all feature game outcomes that exceed the max win limit. The technical effect may be achieved by performing additional, less, or alternate steps, including those discussed elsewhere herein.

In some embodiments of the disclosed technology, game instances of electronic games provided by EGMs may provide opportunities for bigger wins in the form of large monetary prizes, bonus game triggers, free games, or the like. In these example implementations, total win amounts may exceed specific requirements or regulations set forth by game regulators. Additionally, or alternatively, regulators may set forth requirements or regulations for not only max win prize amounts, but other game aspects as well. Other game aspects that may be regulated may include, for example, max bet, max win per single spin prize amount, total win of an entire bonus game prize amount, total win prize amount of a single spin, total win of the entire bonus game round prize amount, or the like.

In some embodiments of the disclosed technology, the design of a game may be configured with a pre-truncation operation. The game may be reconfigured, for example, during a porting process of the game. The disclosed porting process of the game allows for the game to be operational within various markets each having respective requirements or regulations as described herein. For example, first market may have max win requirements that are less stringent than a second market. To be operational within the second market, the disclosed porting process may be used to make the game playable in the second market using the max win requirements of the second markets. Additionally, the disclosed porting process may take RTP into consideration to ensure fairness and be compliant with other regulations that may exist within the second market.

In some embodiments, the pre-truncation operation may include a simulation of the game to be ported. For example, the game simulation may be used for porting the game to a certain market with max win requirements. The game simulation may be used to capture an experience of the game and simulate, or calculate, output of a finite number of outcomes of the game. In some cases, the finite number may be in the millions (e.g., one million, ten million). The output of the finite number of outcomes would only include vital data needed, for example only the “winning” outcomes would be collected while non-winning outcomes would be ignored. Outcomes that exceed the max win requirements of the certain market may be labeled, or identified, and removed from the outcome data, leaving a subset of game outcomes that satisfy regulatory requirements of the certain market (e.g., satisfy the max win requirements). In one example, for a spinning reel game, the process may truncate all the spin outcomes that are over a certain threshold as set forth by a regulatory authority. In another example, for the spinning reel game, the process may truncate all the spin outcomes that include a jackpot multiplier that would cause a winning outcome above the certain threshold. In yet another example, for the spinning reel game, the game may have a bonus wheel that is triggered during gameplay. In this example, the process may truncate all the spin outcomes of the bonus wheel that exceed the certain threshold.

As a result of truncation of game outcomes, the RTP of a game may be affected. For example, by excluding a subset of the game outcomes, especially high-value prize amounts, the RTP of the game may drop below unacceptable, or non-compliant, levels. In one non-limiting example, prior to truncation, a game may have an RTP of 94%. After truncation, the game's RTP may drop to 90%. To account for this, some of the game outcomes kept after truncation may be weighted. For example, using a weighted table, the frequency of some of the game outcomes (e.g., game outcomes with large prize amounts) may be increased to raise the RTP to an acceptable level (e.g., 94%). Additionally, or alternatively, the frequency of some of the game outcomes may be decreased. Additional manipulation may include the frequency increase of game features, such as bonus spins, free games, bonus wheels, or the like.

For purposes of this disclosure, the term “max win requirements” refers to a parameter, or a set of parameters set by a regulatory authority, such as a casino or lottery regulation entity. Additionally, “max win requirements” may be used interchangeably with other parameters that may be set by the regulatory authority, such as max bet, max win per single spin prize amount, total win of an entire bonus game prize amount, total win prize amount of a single spin, total win of the entire bonus game round prize amount, or the like.

### Exemplary Computing System and Environment

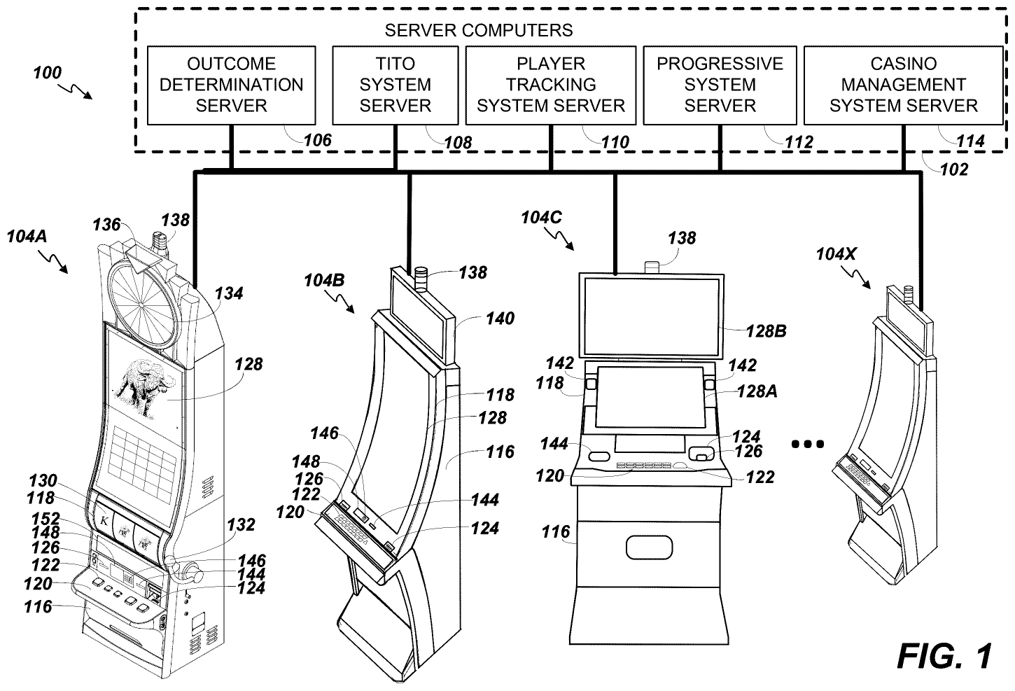

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (Wi-Fi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino-issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique barcodes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

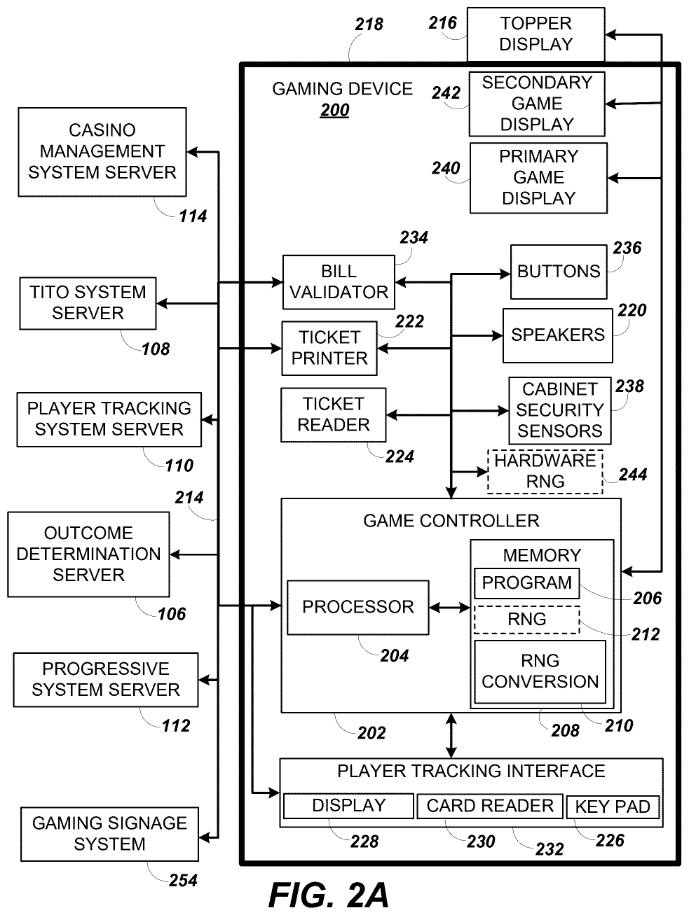

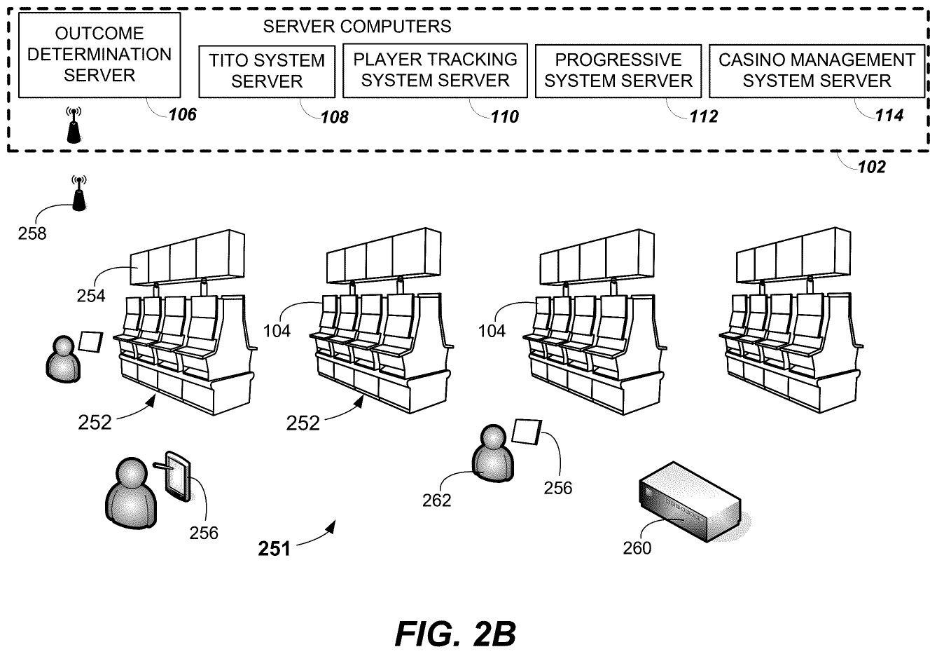

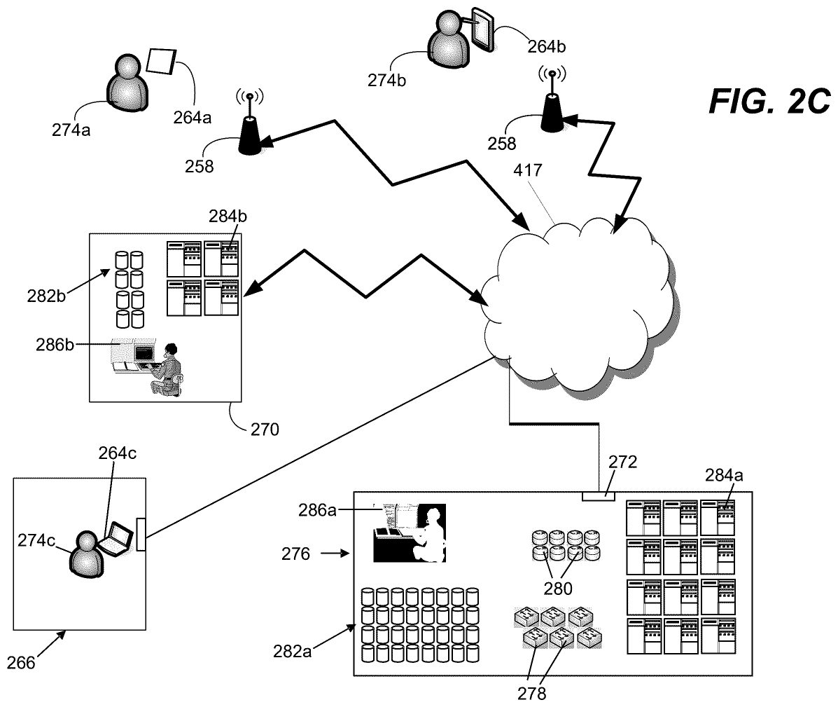

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints barcoded tickets or other media or mechanisms for storing or indicating a player's credit value, a ticket reader 224 which reads barcoded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memory devices 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs the game outcome on one or more of the primary game display(s) 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during the course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., Wi-Fi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate case of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

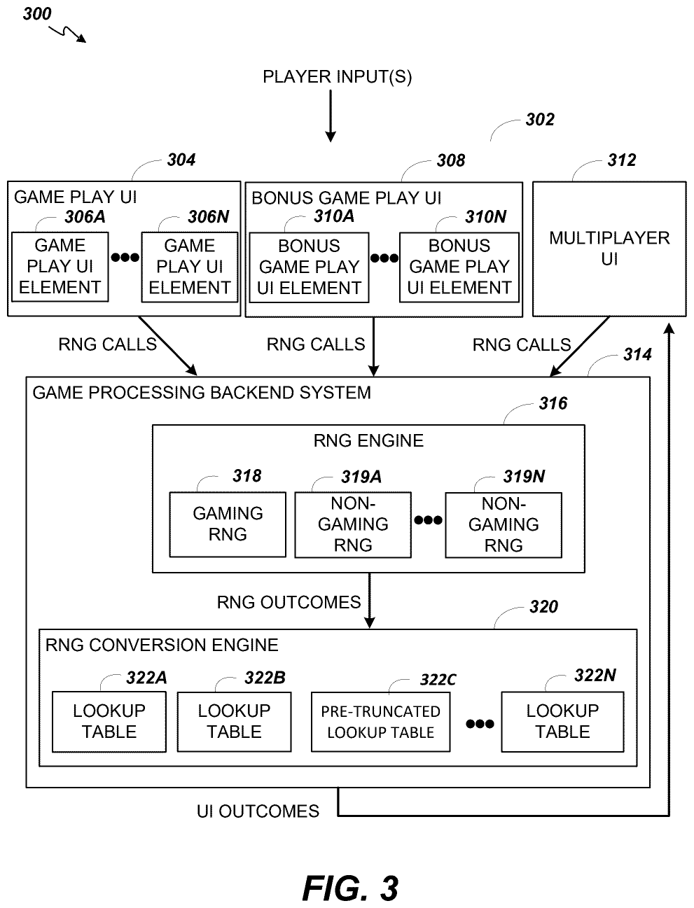

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

According to one or more embodiments, one or more lookup tables 322A-322N includes a pre-truncated lookup table 322C. The pre-truncated lookup table 322C may be generated prior to runtime to record all allowable outcome permutations for a game. In some embodiments, the pre-truncated lookup table may be generated from all possible outcomes of random number generator (RNG) calls for the game. The potential outcomes are then reduced to exclude any outcomes that fail to satisfy an inclusion criterion. For example, in a max win game, potential outcomes for a win that exceeds the max win may be excluded. As another example, in a nudge-based game, such as a Georgia COAM game, an outcome that results in an immediate win may be excluded. Each record within this data structure may correspond to a unique outcome pattern, comprising indices or direct representations for each reel stop, as well as metadata fields identifying outcome classification (win/loss), win types (e.g., symbol match, bonus trigger), and reward values (monetary credits, feature unlocks, etc.). Thus, during gameplay, when a wager is made, the outcome may be selected from the pre-truncated table rather than one or more reel strips.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

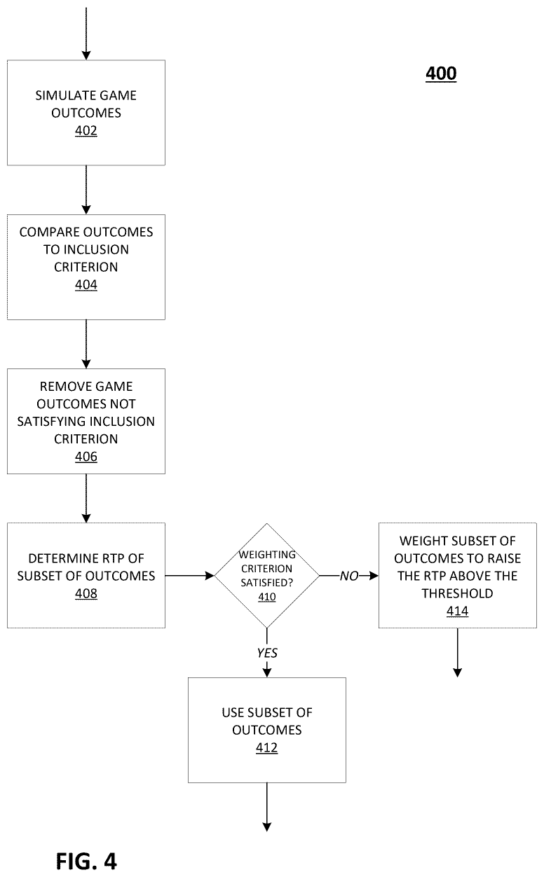

FIG. 4 depicts a flowchart 400 of an exemplary technique for performing a pre-truncation operation to port an electronic game for improved gaming device operation and capability. In some embodiments, the technique depicted in FIG. 4 is particularly relevant to gaming markets that impose a max win requirement, for example requiring that a win amount should not exceed a predefined threshold. The pre-truncation operation illustrated in the flowchart is designed to align with such win constraints by removing potential game outcomes that would exceed max win limits prior to deployment, thereby eliminating the need for outcome truncation during gameplay. The processes of flowchart 400 may be performed by a computing device, such as a computing device used to configure a gaming device, such as gaming device 104A shown in FIG. 1. Alternatively, processes of flowchart 400 may be performed by one or more server computers 106, 108, 110, 112, or 114, as shown in the exemplary configuration illustrated in FIG. 1. In yet another example, method 400 may be performed during initial configuration of a particular game title on a gaming device prior to deployment (e.g., before being made available for gameplay).

In some embodiments, the game title is to be deployed in an environment that is subject to regulatory oversight, such as a casino floor or the like. For example, the game title may be a so-called Class III game (e.g., slot machine) that is to be deployed within an environment that is subject to one or more regulatory parameters. Regulatory parameters may include, for example, max win requirements, RTP, or the like. Regulatory parameters may be determined by local or state governments, regulatory commissions, or the like. In some embodiments, regulatory parameters may differ between jurisdictions. For example, a first jurisdiction may set a threshold for total win amount for a game feature while a second jurisdiction may set a threshold for total win amount per spin of a game instance. In yet another example, a third jurisdiction may set multiple thresholds (e.g., max win amount per spin, max win amount per game feature, max win amount for entire game instance, etc.).

The flowchart 400 may include, at block 402, simulating a game title to generate a plurality of game outcomes. The plurality of game outcomes may include a complete set of potential game outcomes for the game title. According to some embodiments, the simulation may be performed many times (e.g., one million times, ten million times) to produce every outcome of the game title with a high level of confidence (e.g., 99.9%). In this simulation stage, every relevant random number generator (“RNG”) call that would normally occur during live game play may be reproduced so that each simulated outcome corresponds to an actual, executable sequence of RNG calls.

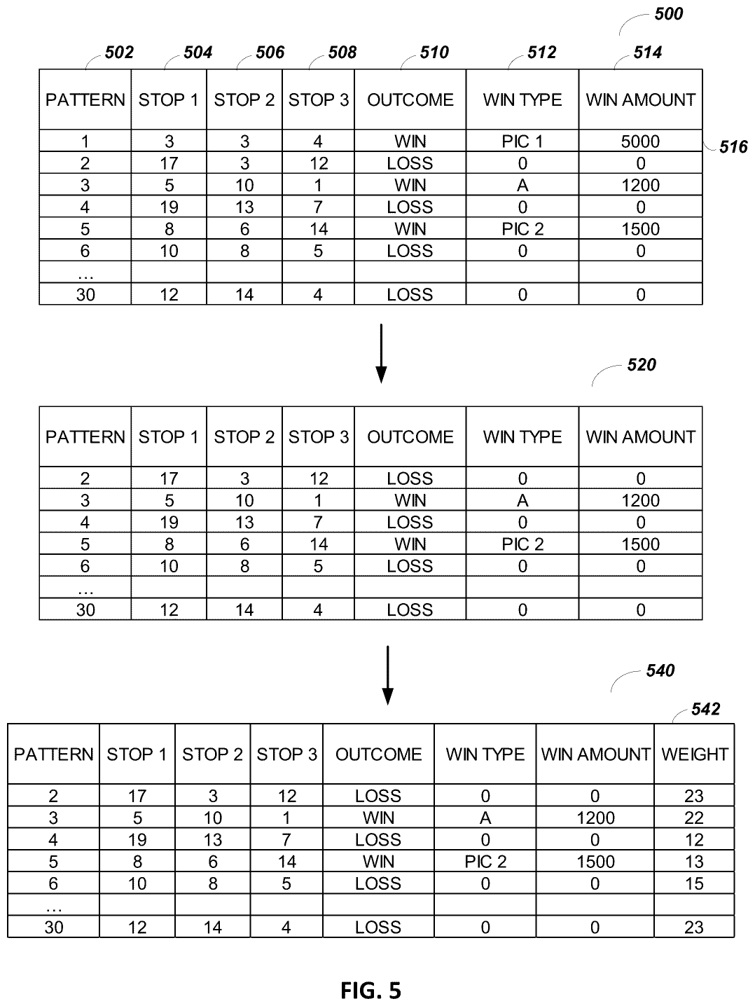

Turning to FIG. 5, an example diagram of a set of data structures is presented. Data structure 500 shows a table of game outcomes. A record for each potential outcome is shown to include a pattern number 502, as well as a value associated with an index for the symbol selected for each reel. The example data structure 500 may correspond to a three reel game. The data in stop 1 504 may refer to an RNG index for the symbol outcome for a first reel. Similarly, the data in stop 2 506 may refer to an RNG index for the symbol outcome for a second reel, and the data in stop 3 508 may refer to an RNG index for the symbol outcome for a third reel. In some embodiments, other data may be used to index the values. Alternatively, the symbol values themselves may be incorporated into the data structure. In addition, the data structure 500 may include an outcome classification 510, such as whether the spin pattern results in a win or a loss. The data structure 500 may also capture a win type 512, such as a symbol or symbol type causing the win, along with a win amount 514. The win amount 514 may be a monetary credit value, a bonus or feature game classification, or the like.

Returning to FIG. 4, at block 404, game outcomes compared against an inclusion criterion. In some embodiments, the game outcomes may be labelled as satisfying and/or not satisfying an inclusion criterion. Labelling may involve setting a flag in a data structure that maps each outcome to its underlying RNG sequence and to any associated contextual data. The inclusion criterion may be set based on one or more parameters (e.g., max win requirements, bonus game limits, free spin limitations, etc.) as determined by predefined rules. At block 406, all labeled game outcomes, creating a subset of game outcomes that comply with the inclusion criterion. The removal process produces a remainder set of the potential outcomes that contains only game outcomes that satisfy an inclusion criterion. As shown in FIG. 5, data structure 520 shows an example subset of game outcomes that satisfy the inclusion criterion. In the example shown, the inclusion criterion may be based on a max win of $4000. To that end, Pattern 1 516 may be determined to fail to satisfy the inclusion criterion, and may be excluded from data structure 520 after the exclusion process.

The flowchart 400 proceeds to block 408, where a return to player (RTP) or other outcome metric is determined for the subset of outcomes. In some embodiments, the simulated game outcomes determined at block 402 may be associated with an original set of weights or other metrics corresponding to frequency and/or outcome value. The RTP of the original set of potential outcomes from block 402 may differ from an RTP for the subset generated at block 406 because of the change in potential outcomes and outcome values. In some embodiments, the game controller 202 aggregates the theoretical pays associated with the remaining outcomes and divides that aggregate by the total theoretical wagers represented in the subset, thereby computing a preliminary return-to-player (“RTP”) value for the truncated set.

At block 410, determination is made as to whether a weighting criterion is satisfied. In some embodiments, the weighting criterion may indicate that the RTP is above an RTP threshold is determined. In other embodiments, a determination may be made as to whether the subset of outcomes satisfies a weighting criterion. The RTP threshold or other criterion may be predetermined, such as by the regulatory authority that provided the one or more regulatory parameters above. Additionally, or alternatively, the weighting criterion may be location-based, property-based, game-specific, or the like.

If, at block 410, a determination is made that the weighting criterion is satisfied, then the subset of outcomes are used for providing game outcomes, as shown at block 412. Alternatively, at block 410, when the weighting criterion is not satisfied, the flowchart 400 may include re-weighting the subset of outcomes to raise the RTP above the threshold. In some embodiments, for example, a weighted table can be generated to change the frequency of some of the game outcomes (e.g., game outcomes with large prize amounts) to raise the RTP to satisfy the weighting criterion (e.g., 94%). Additionally, or alternatively, the frequency of some of the game outcomes may be decreased. Additional manipulation may include the frequency increase of game features, such as bonus spins, free games, bonus wheels, or the like.

Returning to FIG. 5, an example data structure 540 is presented in which the reduced game outcomes from data structure 520 are assigned weights 542. The weights 542 may correspond to original weights for each record in the instance that the result of the truncation process satisfies a same weighting criterion. Alternatively, a re-weighting process may be applied to cause the reduced game outcomes to satisfy the weighting criterion.

According to some embodiments, the technique can be used to preprocess gaming data in other scenarios to improve efficiency. For example, some gaming machines may be limited by predefined outcome criteria, such as compliance with requirements for strategy games. To that end, the described technique can be used to filter out winning outcomes, and determine available outcomes which require user skill.

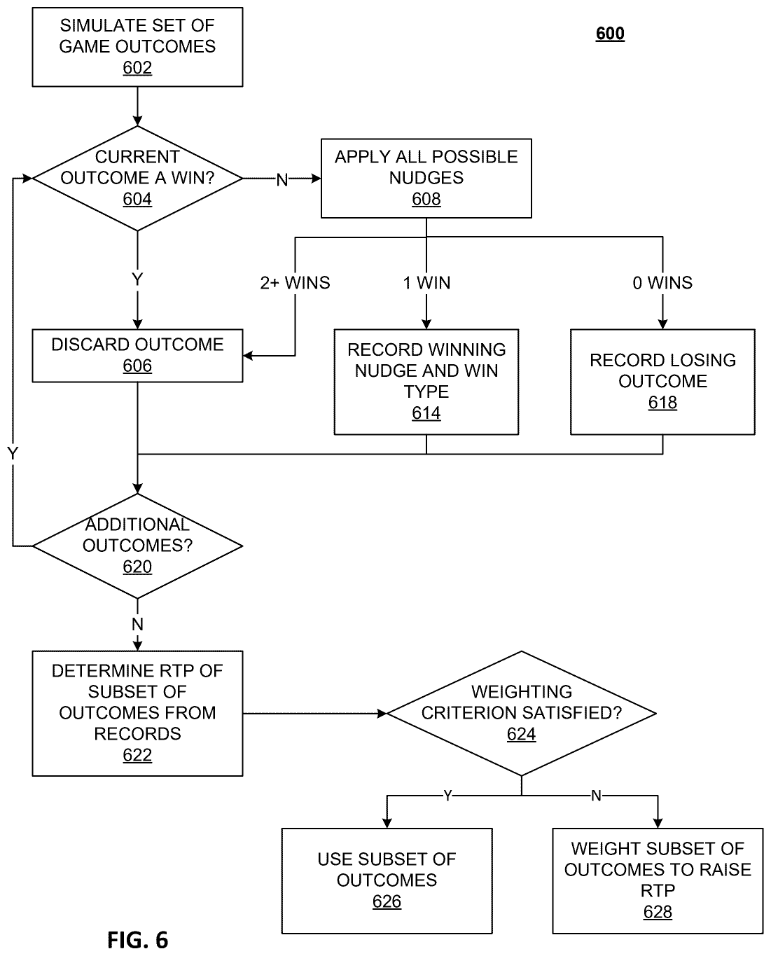

FIG. 6 shows a flowchart 600 of an exemplary technique for performing a pre-truncation operation to preemptively adjust an electronic game operation, thereby enhancing efficiency of the game during runtime. In some embodiments, the technique described in the flowchart is particularly relevant to the Georgia COAM (Coin Operated Amusement Machine) market, or other markets where regulatory requirements impose specific skill element requirements. The pre-truncation operation functions in line with such market-specific constraints by removing potential game outcomes that would result in an immediate win, thereby failing to require a skill element. The processes of flowchart 600 may be performed by a computing device, such as a computing device used to configure a gaming device, such as gaming device 104A shown in FIG. 1. Alternatively, processes of flowchart 400 may be performed by one or more server computers 106, 108, 110, 112, or 114, as shown in the exemplary configuration illustrated in FIG. 1. In yet another example, method 400 may be performed during initial configuration of a particular game title on a gaming device prior to deployment (e.g., before being made available for gameplay).

The flowchart 600 may include, at block 602, simulating a game title to generate a plurality of game outcomes. The plurality of game outcomes may include a complete set of potential game outcomes for the game title. According to some embodiments, the simulation may be performed many times (e.g., one million times, ten million times) to produce every outcome of the game title with a high level of confidence (e.g., 99.9%). In this simulation stage, every relevant random number generator (“RNG”) call that would normally occur during live game play may be reproduced so that each simulated outcome corresponds to an actual, executable sequence of RNG calls. Each “game outcome” corresponds to the complete state of a single spin of the game.

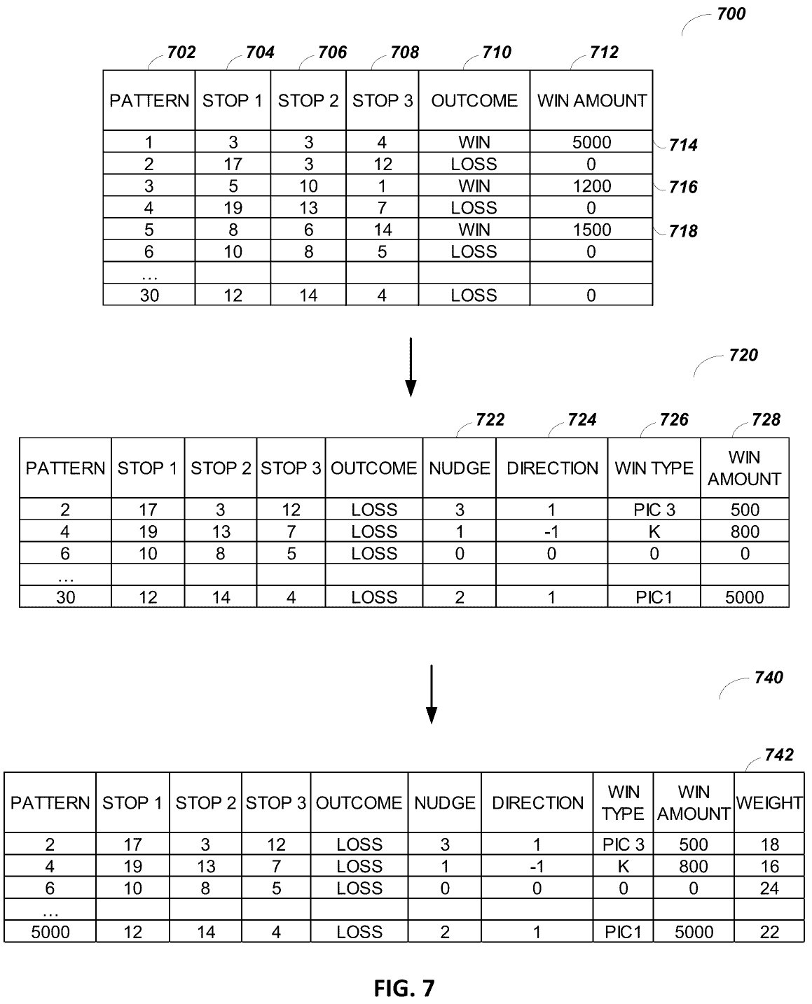

Turning to FIG. 7, data structure 700 shows an example set of potential outcomes from the simulation for a three-reel embodiment. A record for each potential outcome is shown to include a pattern number 702, as well as a value associated with an index for the symbol selected for each reel. The example data structure 700 may correspond to a three reel game. The data in stop 1 704 may refer to an RNG index for the symbol outcome for a first reel. Similarly, the data in stop 2 706 may refer to an RNG index for the symbol outcome for a second reel, and the data in stop 3 708 may refer to an RNG index for the symbol outcome for a third reel. In some embodiments, other data may be used to index the values. Alternatively, the symbol values themselves may be incorporated into the data structure. In addition, the data structure 700 may include an outcome classification 710, such as whether the spin pattern results in a win or a loss. The data structure 700 may also capture a win type 712, such as a symbol or symbol type causing the win, along with a win amount 714. The win amount 714 may be a monetary credit value, a bonus or feature game classification, or the like.

Upon generation of the simulated outcomes, the flowchart 600 proceeds to work through each outcome. At decision block 604, a determination is made as to whether a current outcome under consideration is classified as a win. The determination may be made by referencing a data structure comprising the preliminary simulated outcomes, such as data structure 700 of FIG. 7. As another example, a determination may be made as to whether the simulated outcome satisfies a predefined win condition. This determination may be performed locally by the gaming device 104A or centrally by the server 106.

If the current outcome is an immediate win (i.e., not requiring a nudge), then the flowchart 600 proceeds to block 606 and the current outcome is discarded from the set of potential outcomes for being an uncompliant outcome. For example, to comply with skill-based criteria, an immediate win may be uncompliant. The flowchart 600 then proceeds to decision block 620, where a determination is made as to whether additional simulated outcomes remain unconsidered. If the simulated set generated at block 602 has not been exhausted, flowchart 600 returns to block 604 to evaluate the next candidate outcome.

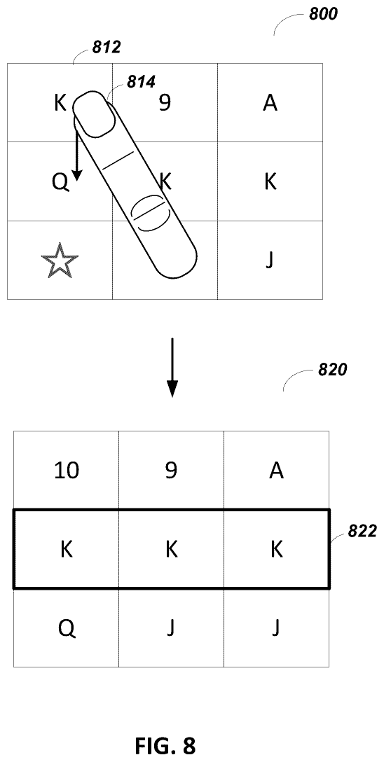

Returning to block 604, if the current outcome is not a win, then the flowchart 600 proceeds to block 608. At block 608, the system applies all possible nudges to determine if any nudges lead to a win and, if so, how many wins result from all possible nudges for a given outcome. In some embodiment, a nudge may be considered an up or down movement by one symbol position on any reel. An example of a nudge is shown in FIG. 8. An initial outcome 800 is shown, which does not include a win. However, if the reel 812 were shifted down one symbol position, then the modified outcome would result in a win. As shown here, a user 814 may cause the reel 812 to be moved to result in the win. This outcome is shown at modified outcome 820, where the win path 822 is shown as resulting from the nudge.

Returning to FIG. 6, the flowchart 600 may proceed in accordance with a number of potential wins result from every combination of nudges. In some embodiments, a single nudge by a single game symbol may be allowable. Alternatively, two or more nudges may be allowable, or a nudge by multiple symbols may be allowable, in which case the determinations made and, thus, the particular paths and/or criteria for a path may differ. For purposes of this example, an embodiment is considered where a single nudge by a single symbol is allowable. If two or more wins can result from all possible nudges, then the flowchart proceeds to block 606 and the current outcome is discarded from the set of potential outcomes for being an uncompliant outcome. The flowchart 600 then proceeds to decision block 620, where a determination is made as to whether additional simulated outcomes remain unconsidered. If the simulated set generated at block 602 has not been exhausted, flowchart 600 returns to block 604 to evaluate the next candidate outcome.

If, at block 608, a current outcome results in a single win, then the flowchart 600 proceeds to block 614, and the winning nudge and win type are recorded. Alternatively, if none of the possible nudges result in a win, then the flowchart proceeds to block 618, and the current outcome is recorded as a loss. In either case, the flowchart then proceeds to decision block 620, where a determination is made as to whether additional simulated outcomes remain unconsidered. If the simulated set generated at block 602 has not been exhausted, flowchart 600 returns to block 604 to evaluate the next candidate outcome.

Turning to FIG. 7, data structure 720 shows an example set of classified outcomes. In particular, the outcomes from data structure 700 have been reduced by removing the outcomes that results in initial wins, shown as record 714, record 716, and record 718. In addition, as each record is processed, the determined nudge information is collected and stored. In the data structure 720, the nudge information is stored as nudge location 722 and nudge direction 724. In addition, new win information is captured, as the wins occur after a nudge, and are not immediate wins. To that end, the data structure 720 includes, for each record, win type 726, and win amount 728, which differ from the initial win information for some of the patterns as initially determined.

Returning to FIG. 6, once all potential outcomes have been evaluated, the flowchart 600 proceeds to block 622 and the system determines an RTP of the subset of outcomes after the outcomes resulting in immediate wins have been discarded. For example, the system may apply a weighting function to the outcomes to take into account frequency of occurrence, win type, win size, or the like. A determination is made at block 624 as to whether a weighting criterion is satisfied. In some embodiments, the weighting criterion may indicate that the RTP is above an RTP threshold is determined. The RTP threshold or other criterion may be predetermined, such as by the regulatory authority that provided the one or more regulatory parameters above. Additionally, or alternatively, the weighting criterion may be location-based, property-based, game-specific, or the like.

If, at block 624, a determination is made that the RTP is above a threshold (or, in some embodiments, that the weighting threshold is satisfied), then the subset of outcomes are used for providing game outcomes, as shown at block 626. Alternatively, at block 628, when the RTP is not above the threshold, or not satisfying the weighting threshold, the flowchart 600 may include re-weighting the subset of outcomes to raise the RTP above the threshold. In some embodiments, for example, a weighted table can be generated to change the frequency of some of the game outcomes (e.g., game outcomes with large prize amounts) to raise the RTP to satisfy the weighting criterion (e.g., 94%). Additionally, or alternatively, the frequency of some of the game outcomes may be decreased. Additional manipulation may include the frequency increase of game features, such as bonus spins, free games, bonus wheels, or the like.

Returning to FIG. 7, an example data structure 740 is presented in which the reduced game outcomes from data structure 720 are assigned weights 742. The weights 742 may correspond to original weights for each record in the instance that the result of the truncation process satisfies a same weighting criterion. Alternatively, a re-weighting process may be applied to cause the reduced game outcomes to satisfy the weighting criterion.

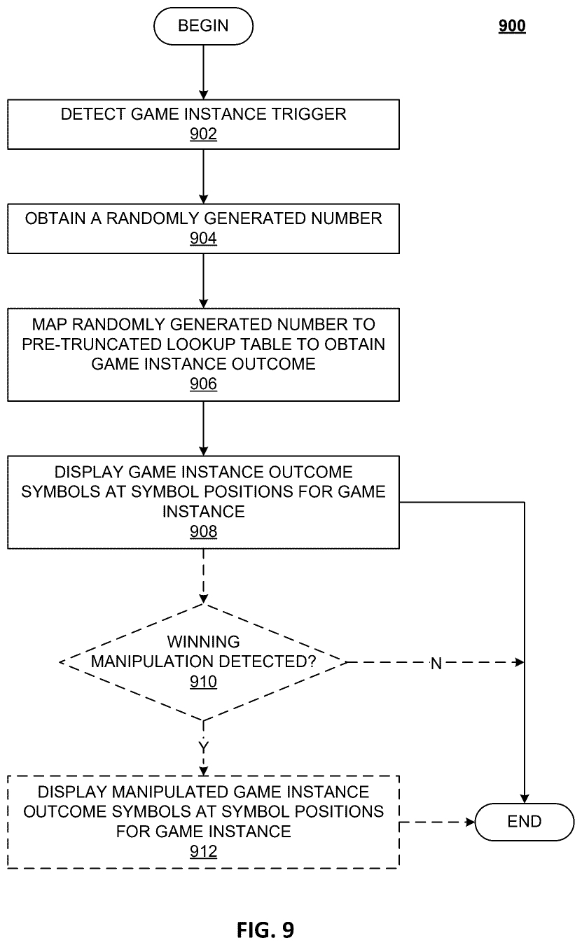

FIG. 9 depicts a flowchart 900 of an exemplary technique for using a pre-truncated lookup table during gameplay. As will be shown, because the lookup table preemptively removes potential outcomes that fail to meet regulatory or other criteria, the need for outcome truncation during gameplay is diminished. In some embodiment, the techniques described herein may be performed, for example, by gaming device 200 of FIG. 2. Although the various process are presented in a particular order, it should be understood that the processes may be performed in a different order. Further, some process may be excluded, or others may be added, in accordance with one or more embodiments.

The flowchart begins at block 902, where a game instance trigger is detected. According to one or more embodiments, the game controller 202 monitors for a player input indicating initiation of a new game instance. Such a trigger may be generated when the player depresses one of the player-input buttons 236, actuates a virtual “spin” icon rendered on primary game display 240, or provides a wager.

At block 904, the gaming device obtains a randomly generated number. In some embodiments, the game controller 292 may issue one or more RNG calls from an RNG engine, such as a hardware random number generator, software-based random number generator, or the like. At block 906, the gaming device maps the randomly generated number to a pre-truncated lookup table to obtain a game instance outcome. The pre-truncated table may include a set of allowable game outcomes, corresponding to game-, location-, or jurisdiction-specific criteria. For example, a pre-truncated table for a maximum win threshold would exclude potential outcomes where the win amount exceeds a specified maximum, ensuring that no single outcome can award more than the allowed limit. In a skill-based game, a pre-truncated table might include only those outcomes that require player interaction, such as nudge-based potential wins, and exclude outcomes that result in immediate wins without player input. Each entry of the lookup table may also include a weight value that biases selection frequency to satisfy a weighting criterion. For example, the weight values may be assigned so that the aggregate return-to-player (RTP) of the available outcomes equals a desired target. The selected entry returns a “game instance outcome,” which comprises a set of symbol identifiers and stop positions for each virtual or mechanical reel represented in the game. In some embodiments, such as a skill-based game or other games requiring user interaction, the pre-truncated lookup table may also include ancillary parameters such as nudge direction and distance when the selected outcome is a nudge-based potential win.

The flowchart 900 proceeds to block 908, where the gaming device displays the game instance outcome symbols at symbol positions for the game instance. For example, the gaming device may render the symbols of the selected game instance outcome in a reel matrix. Other effects may be presented along with the outcome, such as audio, lighting, haptic effects, or the like.

In some embodiments, the flowchart may cease once the game instance outcome is presented. A win amount may be determined and presented, credit may be allocated to the user, and the like. Alternatively, in some embodiments, such as skill-based games, the flowchart continues to account for further user interaction to allow the user to apply a skill to the game. Thus, in optional block 910, a determination is made as to whether a winning manipulation is detected. This may occur, for example, when a player interaction alters the game instance outcome. The determination as to whether the manipulation is a winning manipulation may be based on a comparison of the resulting symbols after user manipulation, comparting a user manipulation to a winning manipulation from the pre-truncated lookup table record for the selected winning outcome, such as a nudge distance and/or direction.

The flowchart then concludes at block 912, where the gaming device displays the manipulated game instance outcome symbols at symbols positions for the game instance. For example, the gaming device may render the symbols of the selected game instance outcome in a reel matrix. Other effects may be presented along with the outcome, such as audio, lighting, haptic effects, or the like. In some embodiments, the flowchart may cease once the game instance outcome is presented. A win amount may be determined and presented, credit may be allocated to the user, and the like.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A non-transitory computer readable medium comprising computer readable code executable by one or more processors to:
perform a game outcome selection operation using a pre-truncated lookup table, wherein the pre-truncated lookup table comprises a comprises a subset of a set of potential outcomes for a set of game symbols, wherein the subset of the set of potential outcomes satisfy an inclusion criterion, and one or more of the set of potential game outcomes which fail to satisfy the inclusion criterion are excluded from the pre-truncated lookup table; and
upon obtaining a game outcome instance from the game outcome selection operation, present the game outcome instance in a set of reels on a user interface.

2. The non-transitory computer readable medium of claim 1, wherein the inclusion criterion corresponds to a maximum threshold win amount.

3. The non-transitory computer readable medium of claim 1, wherein the inclusion criterion corresponds to a winning game outcome.

4. The non-transitory computer readable medium of claim 1, wherein the inclusion criterion is determined for a nudge-based potential win, and wherein the pre-truncated lookup table comprises win parameters for the nudge-based potential win.

5. The non-transitory computer readable medium of claim 4, wherein a potential outcome that comprises an immediate win is excluded from the pre-truncated lookup table.

6. The non-transitory computer readable medium of claim 1, wherein the inclusion criterion comprises a location-specific criterion.

7. The non-transitory computer readable medium of claim 1, wherein the pre-truncated table comprises weighted values for each of the subset of the set of potential outcomes.

8. A method comprising:
simulating a plurality of game outcomes for an electronic game;
determining whether each of the plurality of game outcomes satisfies an inclusion criterion;
excluding one or more of the plurality of game outcomes that fail to satisfy the inclusion criterion to obtain a subset of the plurality of game outcomes; and
generating a weighted table comprising the subset of the plurality of game outcomes to satisfy a weighting criterion,
wherein the electronic game utilizes the weighted table for selecting one or more of the subset of the plurality of game outcomes during a game session.

9. The method of claim 8, wherein the inclusion criterion corresponds to a maximum threshold win amount.

10. The method of claim 8, wherein the inclusion criterion corresponds to a winning game outcome.

11. The method of claim 8, wherein determining whether each of the plurality of game outcomes satisfies an inclusion criterion comprises:
determining that a first game outcome of the plurality of game outcomes comprises a nudge-based potential win; and
recording win parameters for the nudge-based potential win,
wherein the weighted table is generated based on the win parameters.

12. The method of claim 8, wherein determining whether each of the plurality of game outcomes satisfies an inclusion criterion comprises:
determining that a second game outcome fails to satisfy an inclusion criterion in response to the second game outcome comprising a plurality of nudge-based potential wins.

13. The method of claim 8, wherein the inclusion criterion comprises a location-specific criterion.

14. The method of claim 8, wherein the subset of the plurality of game outcomes are used for a base game of the electronic game, and wherein the plurality of game outcomes are used for a feature game of the electronic game.

15. A system comprising:
one or more processors; and
one or more computer readable media comprising computer readable code executable by the one or more processors to:
simulate a plurality of game outcomes for an electronic game;
determine whether each of the plurality of game outcomes satisfies an inclusion criterion;
exclude one or more of the plurality of game outcomes that fail to satisfy the inclusion criterion to obtain a subset of the plurality of game outcomes; and
generate a weighted table comprising the subset of the plurality of game outcomes to satisfy a weighting criterion,
wherein the electronic game utilizes the weighted table for selecting one or more of the subset of the plurality of game outcomes during a game session.

16. The system of claim 15, wherein the inclusion criterion corresponds to a maximum threshold win amount.

17. The system of claim 15, wherein the inclusion criterion corresponds to a winning game outcome.

18. The system of claim 15, wherein the computer readable code to determine whether each of the plurality of game outcomes satisfies an inclusion criterion comprises computer readable code to:
determine that a first game outcome of the plurality of game outcomes comprises a nudge-based potential win; and
record win parameters for the nudge-based potential win,
wherein the weighted table is generated based on the win parameters.

19. The system of claim 15, wherein the computer readable code to determine whether each of the plurality of game outcomes satisfies an inclusion criterion comprises computer readable code to:
determine that a second game outcome fails to satisfy an inclusion criterion in response to the second game outcome comprising a plurality of nudge-based potential wins.

20. The system of claim 15, wherein the inclusion criterion comprises a location-specific criterion.
